(19) United States
(12) Patent Application Publication
(10) Pub. No.: US 2014/0166208 A1
(43) Pub. Date: Jun. 19, 2014

(54) PREFORMING PRE-PREG

(71) Applicant: Marcel J. Schubiger, Galgenen 8854 (CH)

(72) Inventor: Marcel J. Schubiger, Galgenen 8854 (CH)

(73) Assignee: IQ TEC SWITZERLAND GMBH, Galgenen (CH)

(21) Appl. No.: 14/129,779

(22) PCT Filed: Jun. 26, 2012
(86) PCT No.: PCT/IB2012/053235

§ 371 Date: Dec. 27, 2013

Related U.S. Application Data
(60) Provisional application No. 61/501,664, filed on Jun. 27, 2011.

(51) Int. Cl. B29C 70/30

(52) U.S. Cl. CPC B29C 70/30
USPC 156/468

(57) ABSTRACT

A tool for manufacturing a preform assembly; comprising an inverted “Upper Skin” Preform Mold (101) having mold surface (75) turned up-side down so that gravity will help hold pre-preg layers on the mold surface (75) during performing; a “Web” Preform Mold (105) with flanges (76); and a “Lower Skin” Preform Mold (110), having a mold surface (78) with leading edge overlap extension (79) and trailing edge overlap extension (80).

### FIELD OF USE

This application refers to assembling, forming, and curing composite parts from pre-preg materials. More specifically, the present application refers to assembling, forming, and curing large parts, e.g. wind turbine blades.

### BACKGROUND

Pre-preg is a term for “pre-impregnated” composite fibres. These usually take the form of a weave or are uni-directional. They already contain an amount of the matrix material, e.g., thermoplastic or thermoset resin, used to bond them together and to other components during manufacture. The pre-preg are mostly stored in cooled areas since activation is most commonly done by heat. Hence, composite structures built of pre-pregs will mostly require an oven or autoclave to cure out.

### SUMMARY OF THE INVENTION

A first aspect of the present invention provides a method of forming a free standing uncured or partially cured fiber/resin preform comprising: providing at least one layer(s) of pre-preg on a mold surface; providing a means of applying pressure to the layer/s of solid resin pre-preg tending to form them (it) into a desired shape; providing a means of applying heat to the layers, allowing the resin to melt, adhering the solid resin pre-preg layers together, while further facilitating the conformance of the layers to the desired shape; and cooling and solidifying the preform before the resin is fully cured.

A second aspect of the present invention provides a method of forming a composite article, comprising: providing at least one preform(s), where the preform/s are made with a solid resin pre-preg, wherein the resin is uncured or partially uncured and solid at room temperature; providing a molding surface with the assembled preforms or preform thereon; providing a means of applying pressure to the preforms (or preform) assembly to further consolidate the pre-preg, forming them (it) into a desired shape, and forcing overlapping preform regions together; providing a means of applying heat to the preform(s), melting the resin to further promote conformance to the desired shape, and the adherence of any overlapping preforms to each other; and providing a means of further applying heat (and pressure) to the preform assembly to cure the pre-preg resin and create a co-cured structure.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIGS. 1A-1D depict stages of impregnating a substrate to form a preform before curing, in accordance with embodiments of the present invention;

FIGS. 2-3 depict cross-sectional views of an apparatus 10 for making one tube of a bicycle frame, in accordance with embodiments of the present invention;

FIG. 4 depicts the apparatus 10 depicted in FIG. 3, after bringing the top surface of the mold into close proximity of the bottom surface of the mold, in accordance with embodiments of the present invention;

FIG. 5 depicts a cross-sectional view of the apparatus 10 depicted in FIG. 4, after curing the resin, in accordance with embodiments of the present invention;

FIGS. 6A, 6B depict a flow diagram of a preforming and molding process, in accordance with embodiments of the present invention;

FIG. 7 depicts a preform assembly, e.g. a wind turbine blade, in accordance with embodiments of the present invention;

FIGS. 8-10 depict a cross-sectional view of a tool 100 for manufacturing the preform assembly, e.g., the wind turbine blade, in accordance with embodiments of the present invention;

FIGS. 12-14 depict steps for assembling preforms in each preform mold 101, 105, and 110 with layers of pre-preg, in accordance with embodiments of the present invention;

FIG. 15 depicts vacuum bagging each preform, in accordance with embodiments of the present invention;

FIG. 16 depicts preform assembly steps for co-curing and molding, in accordance with embodiments of the present invention; and

FIGS. 17-18 depict molding preform assembly 170 into a unified structure in accordance with embodiments of the present invention.

### DETAILED DESCRIPTION OF THE EMBODIMENTS OF THE INVENTION

The manufacturing of composite structures using fibrous “pre-preg” is typically associated with building up layers of pre-preg on a molding surface, applying heat and pressure to consolidate and cure the material to form a structure. Vacuum bags are often used to provide the pressure, and ovens are often used to provide the heat. Such structures could be as simple as a flat plate or more complex such as a wind turbine blade. In one embodiment, the assembled, formed, and cured large parts, e.g., wind turbine blades, may contain more than 10 tons of fiberglass and resin per blade. The term pre-preg is used herein to describe a combination of reinforcing fibers such as glass or carbon fiber, with a resin such as epoxy or polyester, in a layer format, where the ratio of fiber to resin is controlled to have the proper proportions to produce the intended structure. And, the resin is not solid at room temperature, allowing the pre-preg to be formed to a desired shape. “Drapable” is the term often used to describe the formability of a pre-preg. The resin is typically soft and taffy-like in consistency. In addition, the pre-preg layers can adhere lightly to each other during assembly. Such adherence is typically termed “tack” and may be facilitated by warming the pre-preg. Such tack allows the assembly of pre-preg to hold together as the assembly and processing proceed. “Tack” and “Drape” are often used to describe the handling characteristics of a pre-preg. The weight of resin per unit area and the weight of the fiber per unit area are controlled and constant.

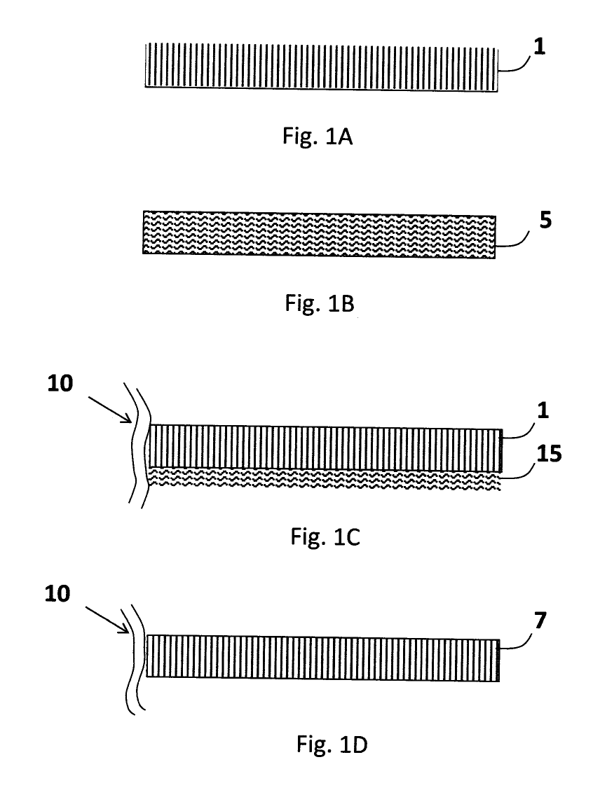

The pre-preg resin can be fully impregnated into the fiber, wetting each fiber, with a very low void (bubble) content, as illustrated in FIG. 1 D. Alternatively, the pre-preg resin can be partially impregnated into the fiber layer, where much of fiber is dry and untouched by the resin, as depicted in FIG. 1C.

FIG. 1A depicts a cross-sectionals view of a resin layer 1.

FIG. 1B depicts a cross-sectional view of a fiber layer 5.

FIG. 1C depicts a cross-sectional view of a pre-preg 10 after partially impregnating the resin layer 1 into the fiber layer 5. In this embodiment, a remaining portion 15 of the fiber 5 is dry and untouched by the resin layer 1.

FIG. 1D depicts a cross-sectional view of the pre-preg 10 after fully impregnating the resin layer 1 into the fiber layer 5. In this embodiment, the resin 1 has been fully impregnated into the fiber 5, wetting each fiber, with a very low void (bubble) content, forming a resin impregnated layer 7 of the pre-preg 10.

Fully impregnated pre-preg generally requires a debulking procedure every few plys or so, because the fully impregnated pre-preg, with its soft resin, can trap air between layers that will not come out during the vacuum bag curing. Such debulking requires the application of pressure, and/or vacuum and pressure to remove the air pockets before subsequent layers can be applied. If there are many layers, multiple debulking cycles will be required. The debulking cycles are time consuming and labor intensive, and may be tolerable for aerospace parts, but are unacceptable for cost critical components like wind turbine blades for example. Partially impregnated pre-preg does not typically require a debulking cycle because the dry fiber provides a path for the air to be removed under vacuum and/or pressure.

### 1.1 Preforming Before Curing

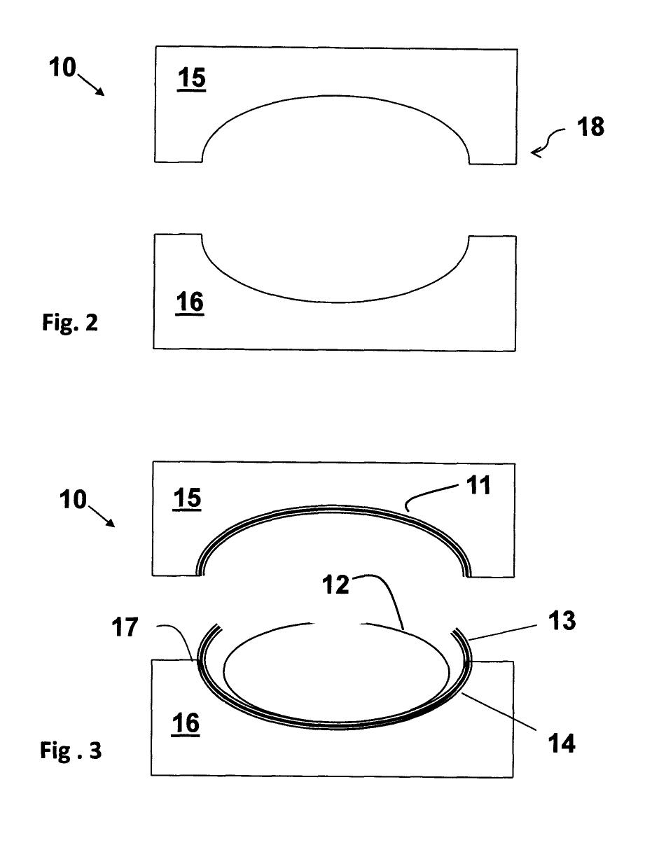

Preforming of pre-preg is often used when making complex composite parts, wherein a number of uncured pre-preg preforms are brought together before the final heat and pressure are applied to cure the part. Unless defined otherwise, the term “preform” is used herein to describe a number of layers of pre-preg tacked together in a particular shape. Pre-preg preforms are generally made in a hard tool to support the preform which does not have good free standing capability because of the soft resin. A typical application is in the making of one-piece carbon/epoxy bicycle frames. The sequence depicted in FIGS. 2-5 illustrates an apparatus 10 for manufacturing one tube of this type of bicycle frame.

FIG. 2 depicts a cross-sectional view of an apparatus 10 for making one tube of a bicycle frame made with carbon/epoxy pre-preg. The apparatus 10 comprises a mold 18 having a top molding surface 15 and a bottom molding surface 16.

FIG. 3 depicts a cross-sectional view of an apparatus 10 for making one tube of a bicycle frame made with carbon/epoxy pre-preg after tacking together layers 11 of pre-preg, and also tacking the layers 11 to the top mold surface 15, creating one preform. Layers 14 of pre-preg are also tacked into the bottom surface of the mold 16, creating a second preform. Some pre-preg extends beyond the parting line 17 of the bottom surface of the mold 16, forming pre-preg extensions 13, that may overlap the pre-preg in the top mold surface 15 and create a uniform structure 19 when complete.

A bladder 12 is inserted between layers 11, 14, to be later inflated to push the pre-preg against the top and bottom mold surfaces 15, 16, so that the pre-preg extensions 13 that overlap the pre-preg in the top mold surface 15 create a uniform structure 19 when complete.

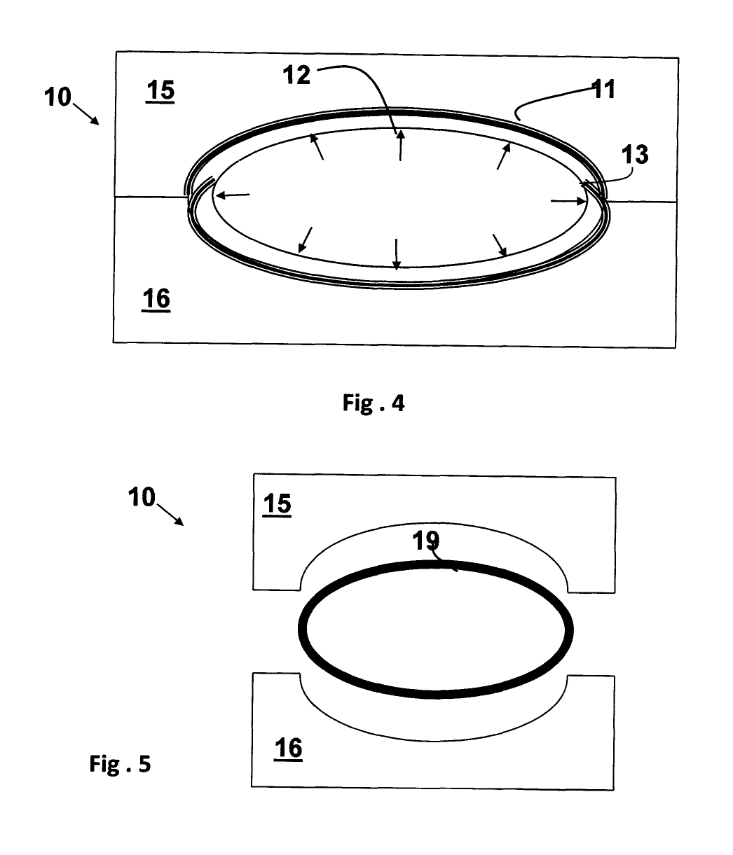

FIG. 4 depicts the apparatus 10 depicted in FIG. 3, after bringing the top surface of the mold 15 into close proximity of the bottom surface of the mold 16, by moving the top surface 15 toward the bottom surface 16 of the mold 18. The bladder 11 is concurrently inflated to push the pre-preg against the top and bottom 15, 16 surfaces of the mold 18. The bottom pre-preg extensions 13 overlap the upper pre-preg and are laminated together creating a uniform structure 19. The mold 18 is then heated to cure the resin.

FIG. 5 depicts a cross-sectional view of the apparatus 10 depicted in FIG. 4, after curing the resin, and removing the uniform structure 19 from the top and bottom surfaces 15, 16 of the mold 18.

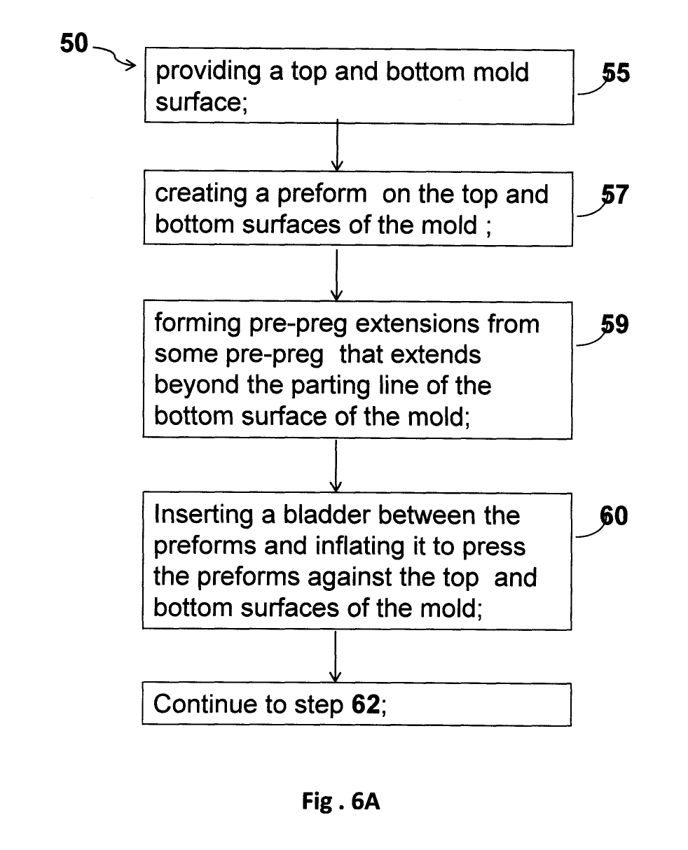

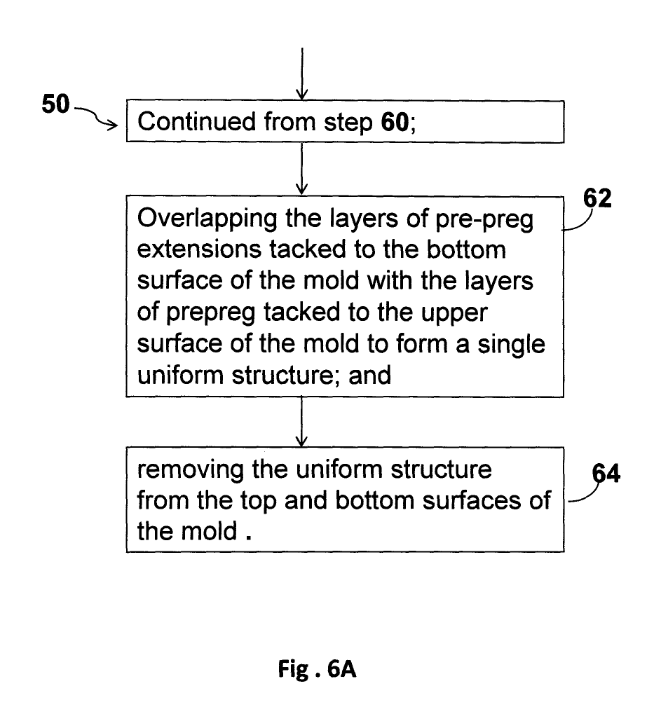

FIGS. 6A, 6B depict a flow diagram listing steps 55, 57, 59, 60, 62, and 64 of a preforming and molding process 50 that works for small parts, using the apparatus 10 depicted in FIGS. 2-5 for making a large variety of composite structures.

However, the process 50, depicted in FIGS. 6A, 6B, is not practical for large parts where large amounts of material need to be suspended in the upper mold, or where some preforms need to be free standing. A large wind turbine blade could have many tons of material in the upper mold surface 15, making this type of molding impractical with current soft-resin pre-preg. Large preforms of either fully impregnated or partially impregnated pre-preg are not free standing, and will droop and deform under their own weight because the resin is soft. Thus an assembly of large preforms is not practical with pre-pregs made with soft resin.

### 2 Solid Resin Pre-Prep “SR-Prepreg”

Many of the manufacturing shortcomings described above can be overcome by a process utilizing pre-preg with a solid resin, termed herein as solid resin pre-preg “SR-perpreg”. The resin is solid at room temperature, weak structurally, and will crack easily. Many uncured epoxy and polyester resins have these characteristics. SR-pre-preg can be used to make preforms of a large size because the weak resin when combined with reinforcing fiber is strong enough to enable large free standing preforms, that will hold shape under their own weight.

The advantages of this process using SR-pre-preg is outlined below.
1) The SR-pre-preg is conformable because the uncured resin cracks easily, allowing individual layers of pre-preg to conform to a desired shape during preforming without adversely effecting the fibers.
2) The solid resin pre-preg allows the evacuation of air between layers either through the fabric itself as in a partially impregnated pre-preg, or through the small gaps between layers as in a fully impregnated pre-preg because the pre-preg surface is solid and rough. The roughness promotes open connected spaces between layers, and the solid resin will not flow into these spaces at room temperature. Thus the air can be removed when vacuum is applied, as under a vacuum bag for example. There is no practical limit to the number of layers that can be processed at once because the air can get out from each and every layer, and from between layers. No intermediate debulking cycles are required even with the fully impregnated solid resin pre-preg.
3) The resin can be melted at elevated temperatures, allowing the layers to consolidate and adhere together. The resin can partially or fully fill the open spaces within the preform and between layers at this time.
4) The resin can be cooled from the preforming temperature before it is fully cured (if cured at all), and convert to a solid at room temperature. Even though it may be a weak solid.
5) Preforms created this way are free standing and can be assembled into complex structures before final cure, because they can support their own weight without deforming.
6) Applying heat and pressure to the assembled preforms will cause the layers to further consolidate, and move together and co-cure any overlapping regions between preforms.
7) The structure can then be cured with additional heat.
8) The final result is a one-piece co-cured structure with no secondary bonding of components.

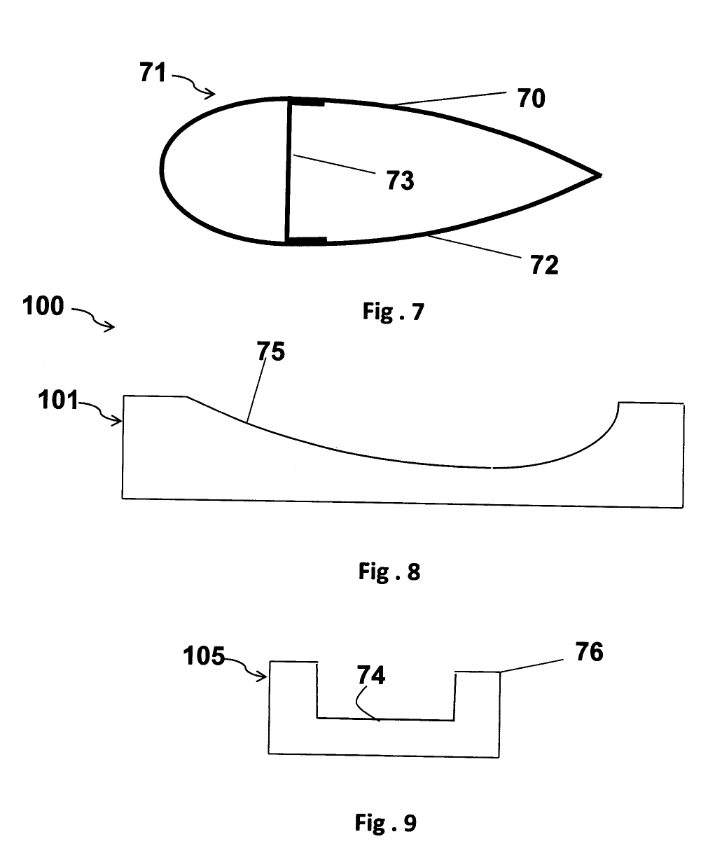

FIG. 7 depicts a preform assembly 71, e.g. a wind turbine blade, having three basic components: an upper skin 70, a lower skin 72 and an interconnecting web 73.

FIGS. 8-10 depict a cross-sectional view of a tool 100 for manufacturing the preform assembly 71, e.g., the wind turbine blade. The tool 100 may include preform molds 101, 105, and 110.

FIG. 8 depicts a cross-sectional view of an inverted “Upper Skin” Preform Mold 101 having mold surface 75 turned upside down so that gravity will help hold pre-preg layers on the mold surface 75 during preforming.

FIG. 9 depicts a cross-sectional view of a “Web” Preform Mold 105 with flanges 76.

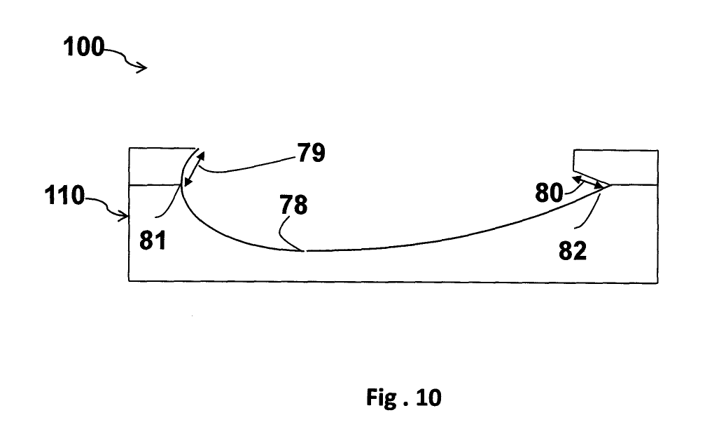

FIG. 10 depicts a cross-sectional view of a “Lower Skin” Preform Mold 110, having a mold surface 78 with leading edge overlap extension 79 and trailing edge overlap extension 80.

Overlap extensions 79, 80 extend the skin on both the leading edge 79 and trailing edge 80, and provide leading edge overlap joint 81 and trailing edge overlap joint 82 with the upper skin 72 to make the unified structure 70 when co-cured with the upper skin 72. No secondary bonding will be required to join the upper and lower skin 72, 74.

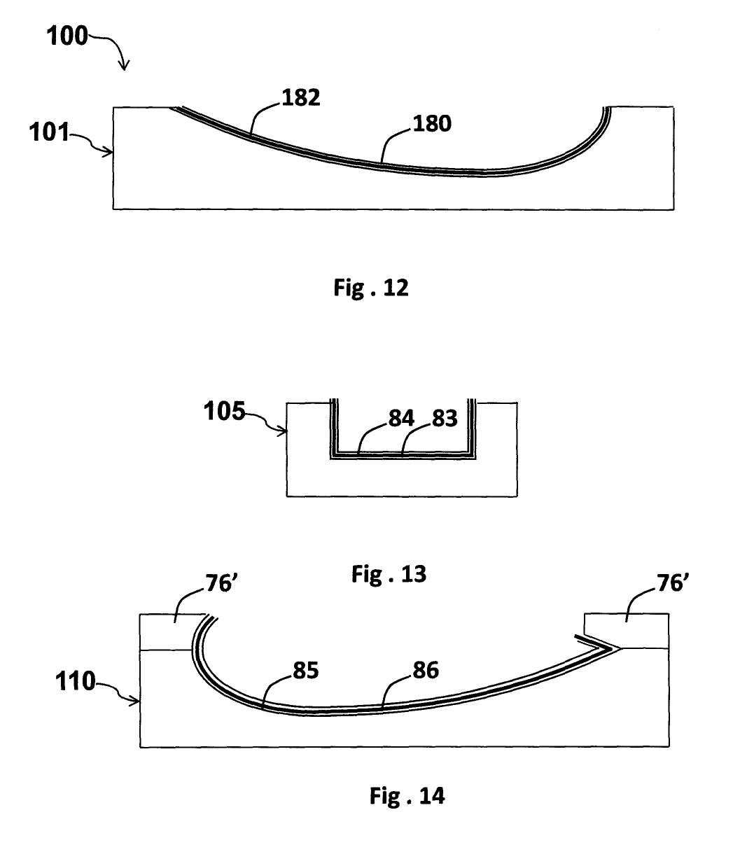

FIGS. 12-14 depict steps for assembling preforms in each preform mold 101, 105, and 110 with layers of pre-preg, using the apparatus 100 depicted in FIGS. 8-10 for making a large variety of composite structures.

FIG. 12 depicts FIG. 8 after layers 182 of preform 180 have been applied to the mold surface 75. The preform 180 is appropriate for the upper skin 70 of the preform assembly 71, e.g., the wind turbine blade, depicted in FIG. 7 and described in associated text herein. Local reinforcement, spar cap layers, and a core may also be applied to the mold surface 75.

FIG. 13 depicts FIG. 9 after layers 84 of preform 83 have been applied to the mold surface 74 appropriate for the web 73 of the preform assembly 71, e.g., the wind turbine blade, depicted in FIG. 7 and described in associated text herein.

FIG. 14 depicts FIG. 10 after layers 86 of preform 85 have been applied to the mold surface 78 appropriate for the lower skin 72 of the wind turbine blade 71, depicted in FIG. 7 and described in associated text herein. Local reinforcement, spar cap layers, and a core may also be applied to the mold surface 78.

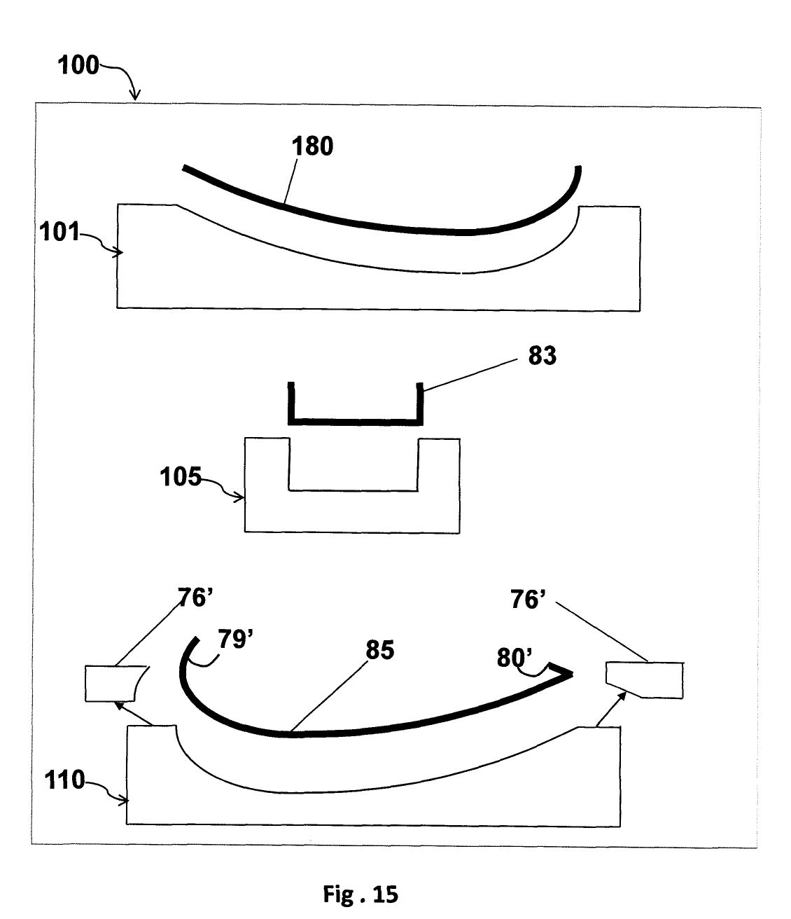

FIG. 15 depicts vacuum bagging each preform 180, 83, and 85 in its respective mold 101, 105, and heat is applied to soften and partially melt the resin. This allows the layers 182, 84, and 86, depicted in FIGS. 12-14 to consolidate and adhere to one another. Heat is removed and the preform cooled before the resin cures, and the resin hardens as it approaches room temperature (because it is naturally solid at room temperature), creating a free-standing preform in each case having a shape of the respective preform 180, 83, and 85

FIG. 15 depicts removing free standing preforms 180, 83, and 85 from the tools, e.g. molds. In some cases the preforms 180, 83, and 85 may remain in the tool, e.g. mold, for the next step. Flanges 76′ may be removable for easy removal of the “Lower Skin” Preform 85, so Leading and trailing edges 79′, 80′ are not damaged during removal.

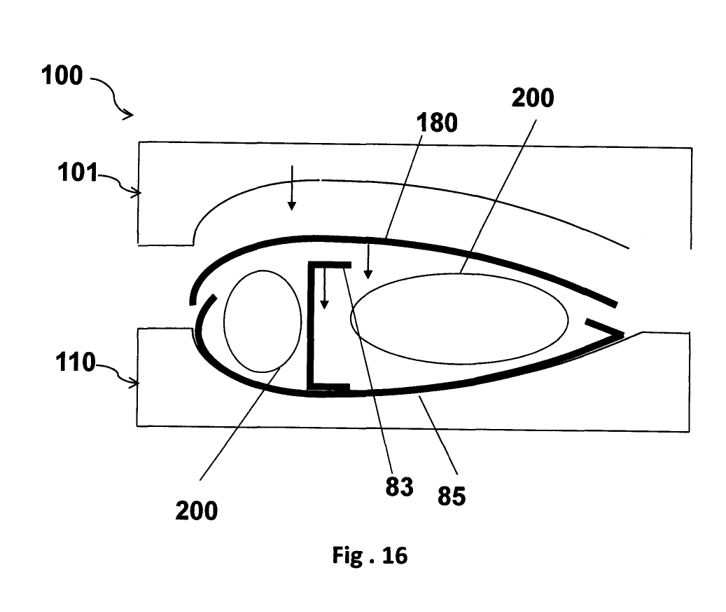

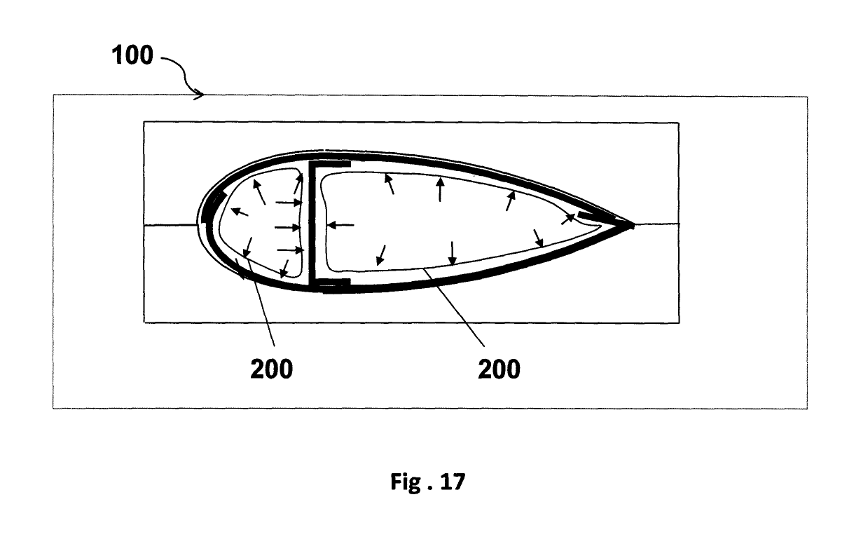

FIG. 16 depicts preform assembly steps for co-curing and molding the upper skin 70, a lower skin 72 and an interconnecting web 73 of the preform assembly 71, e.g., the wind turbine blade, depicted in FIG. 7.

In a first step, free standing lower skin preform 85 is placed in the lower mold 110.

In a second step, free standing web preform 83 is placed on the free standing lower skin preform 85.

In a third step, free standing upper skin preform 180 is placed on top of the free standing web preform 83.

In a fourth step, upper preform mold 101 is placed on top of free standing upper skin preform 180 and connected to the lower mold 110 after the assembly is in place.

Bladders or vacuum bag 200 are placed inside to provide consolidation pressure in the after steps 1 and 2, or whenever appropriate.

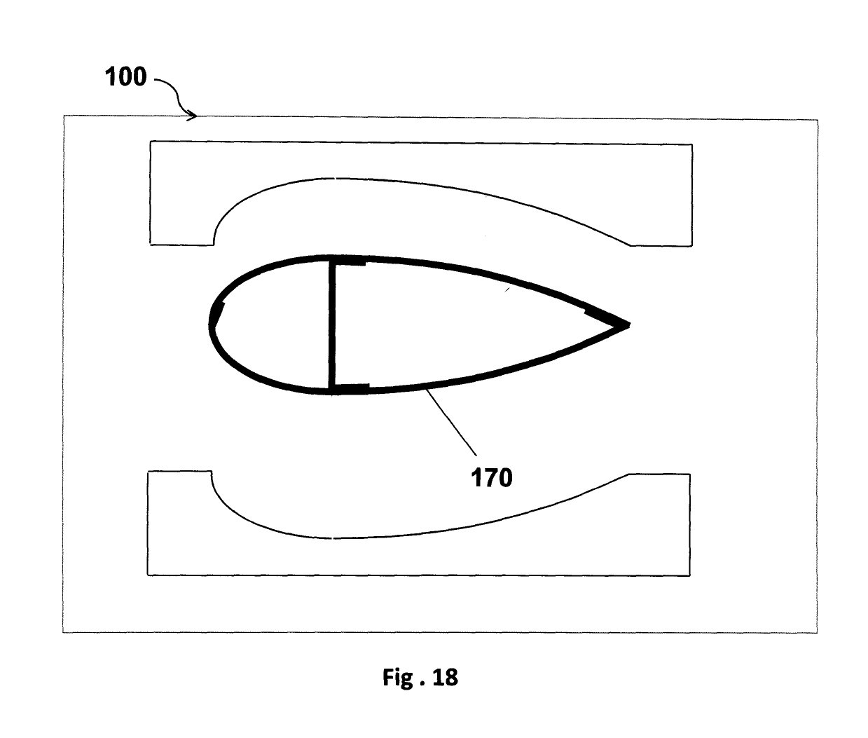

FIGS. 17-18 depict molding preform assembly 170 into a unified structure, and removal of the unified co-structure from the mold 101, 110.

Upper and lower molds 101, 110 are brought together, and connected if necessary. trapping the assembly 170 inside.

In FIG. 17, bladders 200 are inflated, and/or vacuum is applied to the preform assembly 170. Moving the bladder/vacuum bag 200 to apply consolidating pressure to the preform 170 assembly, and form the preform assembly 170 to the desired shape. Note that not all the preforms need to be pushed against a mold surface, in the case of the web 83, forward and aft bladders/vacuum bags 200 push against each other to provide the consolidating pressure. And the web preform 83 will continue to hold its shape even when the resin melts because of the consolidating pressure is balanced and holding it in place.

Overlap preform regions 79′, 80′ are pushed together.

Heat is applied to melt the resin, further consolidate the assembly 170, and cure the resin, producing a unified co-cured structure.

The Unified Co-Cured Structure is Removed From the Mold

The manufacturing process depicted in FIGS. 17-18 can be executed to make either the fully impregnated SR-pre-preg, or the partially impregnated SR-pre-preg, e.g. via the preform assembly 71, e.g., the wind turbine blade. The fully impregnated SR-pre-preg may be preferred because there is less change in thickness during the preforming step, and thus chance for unwanted changes in geometry (slipping layer, fiber kinking, layer wrinkling, and so on).

It is possible to make overlap preform extensions 79′, 80′ without having the preform mold 101, 110 extended into these areas, e.g., “Lower Skin” Preform Mold 110, having a mold surface 78 with leading edge overlap extension 79 and trailing edge overlap extension 80, depicted in FIG. 10, and described in associated text, herein. In such a case, the pre-preg would extend beyond the mold (as in the bicycle tube example) and be captured on both sides by a vacuum bag to provide consolidation pressure for the preforming step. The extensions will be less exact than if they were molded against a mold surface, e.g. leading edge overlap extension 79 and trailing edge overlap extension 8, but the preforms do not need to be as exact as the final shape, because there will be a final molding step that can push them in to the proper position.

Surface coatings can also be applied to the molds between the preforming and final molding steps. This coating can transfer to the final part and form what is typically called a “gel coat”; which is a resin rich layer, usually with color. Such coatings can be provided in the form of a powered paint, sprayed into the mold, where the paint is heated to form a surface film and partially cure “B-Stage” to the extent that it will not wipe off easily, but will still bond to the pre-preg layer in the next step.

Surface coats can also be applied as an uncured resin layer on a carrier such as glass or polyester veil.

Additional Characteristics.

The fully impregnated SR-pre-preg will tend to be closer to the final thickness than the non-solid fully impregnated pre-preg of the same fiber type and configuration. Pre-preg fabrics of woven glass or carbon fiber, for example, are particularly prone “lofting” once they are impregnated, where a solid resin will tend to hold them in “non-lofted” form, while the non-solid fully impregnated pre-preg is soft and will allow the fabric to move to its natural shape, with a bumpy surface, and increased thickness. The SR-pre-preg can make manufacturing easier because there is less change in thickness and less movement during consolidation. The fully impregnated SR-pre-preg is also faster to process into parts because the wet-out and consolidation steps are essentially complete within each layer.

Additional Processes

While the vacuum bag process has been discussed as the main process to provide consolidation and preforming pressure for the present invention, other means of applying pressure may also be used. Preforms can be made in matched tooling in a heated press for example. Or, preforms can be made under a vacuum bag, and the transferred to matched tooling in a press for final consolidation; or both steps may use a press to provide the pressure.

1. A tool for manufacturing a perform assembly, comprising:
an inverted “Upper Skin” Preform Mold 101 having mold surface 75 turned upside down so that gravity will help hold pre-preg layers on the mold surface 75 during performing;
a “Web” Preform Mold 105 with flanges 76;
a lower pre-preg 72, having bottom pre-preg extensions 13 that overlap the upper prepreg; and
a “Lower Skin” Preform Mold 110, having a mold surface 78 with leading edge overlap extension 79 and trailing edge overlap extension 80, wherein the bottom pre-preg extensions 79, 80 overlap the upper pre-preg 70 and are laminated together creating a uniform structure 71, when co-cured with the upper pre-preg 72.

2. The tool of claim 1, said “Lower Skin” Preform Mold 110 comprising a mold surface 78 with leading edge overlap extension 79 and trailing edge overlap extension 80.

3. The tool of claim 2, said overlap extensions 79, 80 having a skin extended on both the leading edge 79 and trailing edge 80, and providing leading edge overlap joint 81 and trailing edge overlap joint 82 with an upper skin 72 to make the unified structure 70 when co-cured with the upper skin 72.

4. The tool of claim 1, comprising inflatable bladders/vacuum bags 200 for applying pressure to a preform assembly 85, 180, and 83 in the molds 101, 105, and 110 to further consolidate the pre-preg, forming it into a desired shape, and forcing overlapping preform regions 79, 80 together.

5-14. (canceled)
